(19) United States
(12) Patent Application Publication
(10) Pub. No.: US 2026/0170847 A1
(43) Pub. Date: Jun. 18, 2026

(54) SYSTEM AND METHOD FOR PERFORMING OBJECT DETECTION BASED ON DISPARITY IMAGE INFORMATION

(71) Applicant: Mercedes-Benz Group AG, Stuttgart (DE)

(72) Inventors: Sebastian Buck, Böblingen (DE); Stefan Gehrig, Altdorf (DE); Hsin Miao, San Francisco, CA (US); Yue Wu, Cupertino, CA (US)

(21) Appl. No.: 18/985,723

(22) Filed: Dec. 18, 2024

(51) Int. Cl. G06V 20/58; G06T 7/215; G06T 7/285; G06V 10/44; G06V 10/46; G06V 20/64; G08G 1/16

(52) U.S. Cl. CPC G06V 20/58; G06T 7/215; G06T 7/285; G06V 10/44; G06V 10/464; G06V 20/64; G08G 1/16; G06T 2207/10012; G06T 2207/30261

(57) ABSTRACT

Systems, methods, and technology for object detection are presented. A communication interface accesses or receives disparity image information from a stereo sensor system of a vehicle. A non-transitory computer-readable medium stores instructions that cause a processing circuit to receive the disparity image information representing the space outside the vehicle; generate a first saliency map that indicates probability of objects in the space outside the vehicle, wherein the first saliency map is generated using a first algorithm based on a first image property; generate a second saliency map that indicates probability of one or more objects in the space outside the vehicle, wherein the second saliency map is generated using a second algorithm based on a second image property different than the first image property and describing change among pixel values of the disparity image information; and identify presence of one or more objects being present outside the vehicle.

### BACKGROUND

In certain vehicles, computing systems are programmed to provide automated driving or driving assistance functions. Such functions may perform obstacle detection, to detect presence of potential hazards, obstacles, or other objects in front of a vehicle, such as an object in the middle of a road on which the vehicle is travelling. The object detection may be performed based on images captured by cameras mounted on the vehicle. By performing the object detection, the computing system on a vehicle may alert a driver of a potential hazard on the road, and/or may determine a path for the vehicle to avoid the hazard.

### SUMMARY

In accordance with various embodiments of the present disclosure, there is provided an object detection computing system. The object detection system may include a communication interface configured to access or receive disparity image information based on sensor information from a stereo sensor system of a vehicle, wherein the disparity image information represents a space outside the vehicle. The object detection system may also include a processing circuit and a non-transitory computer-readable medium. The non-transitory computer-readable medium stores instructions that, when executed by the processing circuit, cause the processing circuit to receive, via the communication interface, the disparity image information representing the space outside the vehicle. The processing circuit generates, based on the disparity image information, a first saliency map that indicates probability of one or more objects being present in the space outside the vehicle, wherein the first saliency map is generated using a first algorithm which is based on a first image property that describes change among pixel values of the disparity image information. The processing circuit also generates, based on the disparity image information, a second saliency map that also indicates probability of one or more objects being present in the space outside the vehicle, wherein the second saliency map is generated using a second algorithm which is based on a second image property different than the first image property, wherein the second image property also describes change among pixel values of the disparity image information. Additionally, the processing circuit identifies, based on both the first saliency map and the second saliency map, presence of one or more objects being present in the space outside the vehicle.

In accordance with various embodiments of the present disclosure, there is also provided a computer-implemented method for object detection. The method may include executing a memory storing instruction by one or more processors, causing the one or more processors to receive, via a communication interface, disparity image information representing a space outside the vehicle. The method may also include generating, based on the disparity image information, a first saliency map that indicates probability of one or more objects being present in the space outside the vehicle. The first saliency map is generated using a first algorithm which is based on a first image property that describes change among pixel values of the disparity image information. Additionally, the method may include generating, based on the disparity image information, a second saliency map that also indicates probability of one or more objects being present in the space outside the vehicle. The second saliency map is generated using a second algorithm which is based on a second image property different than the first image property. The second image property also describes change among pixel values of the disparity image information. Furthermore, the method may include identifying, based on both the first saliency map and the second saliency map, presence of one or more objects being present in the space outside the vehicle.

In accordance with various embodiments of the present disclosure, there is also provided one or more non-transitory computer-readable media that store instructions that are executable by a control circuit. The control circuit receives, via the communication interface, the disparity image information representing the space outside the vehicle. The control circuit also generates, based on the disparity image information, a first saliency map that indicates probability of one or more objects being present in the space outside the vehicle. The first saliency map is generated using a first algorithm which is based on a first image property that describes change among pixel values of the disparity image information. Additionally, the control circuit generates, based on the disparity image information, a second saliency map that also indicates probability of one or more objects being present in the space outside the vehicle. The second saliency map is generated using a second algorithm which is based on a second image property different than the first image property. The second image property also describes change among pixel values of the disparity image information. Furthermore, the control circuit identifies, based on both the first saliency map and the second saliency map, presence of one or more objects being present in the space outside the vehicle.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1A is a block diagram of an object detection computing system which may facilitate a robust object detection based on disparity image information generated by a stereo sensor system, according to an embodiment hereof.

FIG. 1B is a block diagram of in which the object detection computing system is implemented as an ECU of a vehicle, according to an embodiment herein.

FIG. 2A illustrates an example environment for a vehicle having an object detection computing system, which may detect presence of objects in a space surrounding the vehicle, according to an embodiment herein.

FIG. 2B illustrates an example disparity image generated by a stereo camera system, for use in performing object detection, according to an embodiment herein.

FIG. 3 is a flow chart describing an example method of implementing disparity image-based object detection, according to examples described herein.

FIG. 4A is a flow diagram describing the generating of multiple saliency maps based on a disparity image and generating an obstacle map based on the multiple saliency maps, according to embodiments herein.

FIG. 4B depicts an example column of a disparity image, wherein a saliency map may be generated based on pixel values in the column of the disparity image, according to embodiments herein.

FIG. 5 is a flow chart describing an example in which an obstacle map may be generated using steps that involve lifting the saliency maps to a latent vector space, according to embodiments.

FIG. 6 is a flow diagram illustrating the example in which the saliency maps are used to generate vector fields that represent features of the saliency maps in a latent vector space, according to embodiments herein.

### DETAILED DESCRIPTION

One aspect of the present disclosure relates to providing a robust manner of detecting objects in an external environment, such as a space surrounding a vehicle. For instance, the present disclosure may involve a computing system detecting a road hazard or obstacle in front of the vehicle, so as to enable the computing system to control the vehicle to avoid the road hazard or obstacle. The object detection may be performed based on depth information describing a scene in the external environment, such as a disparity image generated by a stereo sensor system installed in the vehicle.

In some scenarios, the road hazard or other obstacles may come in a large variety of shapes, sizes, colors, and general appearance. Thus, it may be difficult to exhaustively catalog every possible obstacle which a vehicle may encounter, but is still important for a control system in a vehicle to be able to detect presence of potential obstacles in a robust manner. The present disclosure discusses a robust object detection technique which may rely on generating multiple saliency maps based on the disparity image. The multiple saliency maps may be generated using different algorithms that leverage different geometric cues for how the object is expected to appear or be represented by the disparity image or other depth information.

In some implementations, the algorithms that generate the saliency maps may involve an algorithm which determines a first derivative among pixel values of a disparity image, and involve another algorithm which determines a second derivative among pixel values of the disparity image. The first derivative may measure a “slant” in pixel values of the disparity image (also referred to as disparity values), while the second derivative may measure a local curvature in the disparity values. In some cases, the computing system may generate a first saliency map by assigning higher saliency values for regions of the disparity image with a lower “slant” in disparity values, and a lower saliency value for regions of the disparity image with a higher “slant” in disparity values. This is because the regions of the disparity image with a “slant” in disparity values may represent a general landscape, such as road surface, that has a steady change in depth as successive portions of the landscape are farther from the vehicle, while regions of the disparity image with no “slant” in disparity values (or a very low slant) may represent an object appearing against the landscape. In some cases, the computing system may generate a second saliency map by assigning higher saliency values for regions of the disparity image with a higher “local curvature” in disparity values, and assigning lower saliency values for regions of the disparity image with a lower “local curvature” in disparity values, because a “curvature” in disparity values may correspond to a transition between a general landscape (e.g., road surface) being captured by the disparity image and a lower portion of an object appearing against the general landscape. In these implementations, the use of both a first algorithm and a second algorithm, such as a “slant-based” algorithm and a “curvature-based” algorithm, to detect an obstacle or other object in a scene may lead to a robust object detection that enables path planning and vehicle control to avoid such an obstacle.

In some implementations, the object detection may involve lifting the saliency maps to a latent vector space. For example, the computing system may use a lifting function to generate vector fields based on the saliency maps, and combine the vector fields. In such implementations, the computing system may use the combined vector fields to generate an obstacle map which identifies presence of one or more obstacles in a space surrounding a vehicle, or more specifically in a space in front of the vehicle.

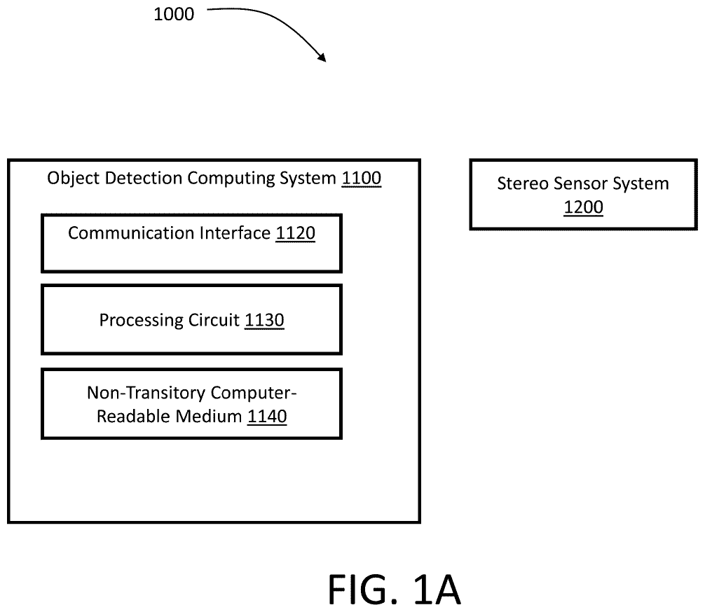

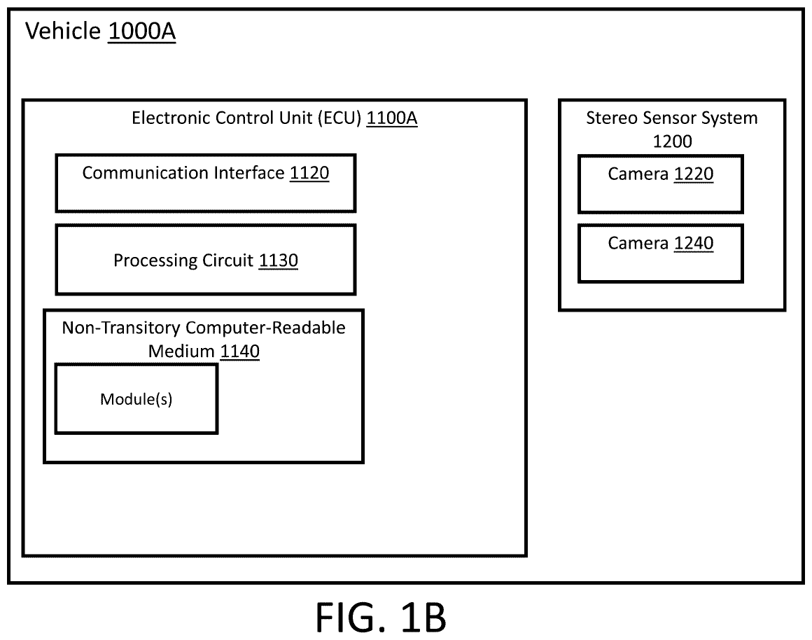

FIG. 1A illustrates an example system 1000, such as a vehicle, configured to detect objects (e.g., obstacles) in a space external to the system 1000. The system 1000 may include, e.g., a stereo sensor system 1200 configured to generate sensor information that describes the space external to the system 1000, and an object detection computing system 1100 configured to receive and process the sensor information.

In an embodiment, the stereo sensor system 1200 may be a stereo camera system that includes at least two cameras or camera lenses that enable the stereo camera system to simulate binocular vision and capture three-dimensional information. More particularly, the stereo camera system may generate one or more disparity images, or more generally disparity image information (e.g., images from the multiple cameras from which a disparity image can be generated), wherein the disparity images may capture objects in a scene or surrounding driving environment, and include depth information for the scene. The depth may refer to, e.g., a distance along a particular axis (e.g., an axis extending in a forward direction from a vehicle) between the objects in the scene and the stereo camera system or the vehicle.

In an embodiment, a depth image which conveys the depth information for a scene may be generated by the stereo sensor system 1200 or the object detection computing system 1100. For instance, the stereo sensor system 1200 may capture at least two simultaneous images of the scene using at least two individual cameras or camera lenses, and map each pixel of one image to a corresponding pixel of the other image, so as to determine a distance between the cameras and a point in space represented by the pixel (e.g., based on parallax of the cameras). The stereo sensor system 1200 may use the determined distances to generate a disparity image, which may be an image that conveys the distance of objects in the scene relative to the stereo sensor system 1200 (or relative to some other point of reference), or more generally conveys depth information for the scene.

In an embodiment, the object detection computing system 1100, such as an advanced driver assistance system (ADAS) unit, may include a communication interface 1120, a processing circuit 1130, and a non-transitory computer-readable medium 1140.

In an embodiment, the communication interface 1120 may be a component that enables communication with at least the stereo sensor system 1200, to receive one or more disparity images or other disparity image information from the stereo sensor system 1200. The communication interface 1120 may include any circuits, components, software, etc. for communicating via one or more interfaces or networks (e.g., including a controller to communicate over peripheral component interconnect Express (PCIe), controller area network (CAN) bus, local area network (LAN), or Ethernet). In some implementations, the communication interface 1120 may include for example, one or more of a communications controller, receiver, transceiver, transmitter, port, conductors, software and/or hardware for communicating data/information.

In an embodiment, the processing circuit 1130 may process disparity image information or other information received via the communication interface 1120. In an embodiment, the processing circuit 1130 may include one or more processors (e.g., CPUs or GPUs), one or more processing cores, a programmable logic circuit (PLC) or a programmable logic/gate array (PLA/PGA), a field programmable gate array (FPGA), an application specific integrated circuit (ASIC), a system on chip (SoC), or any other processing circuit.

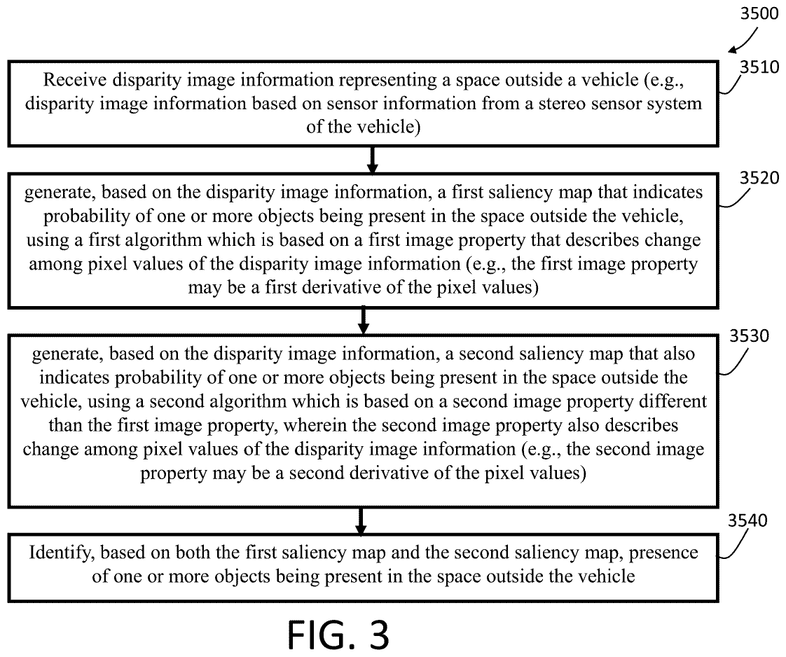

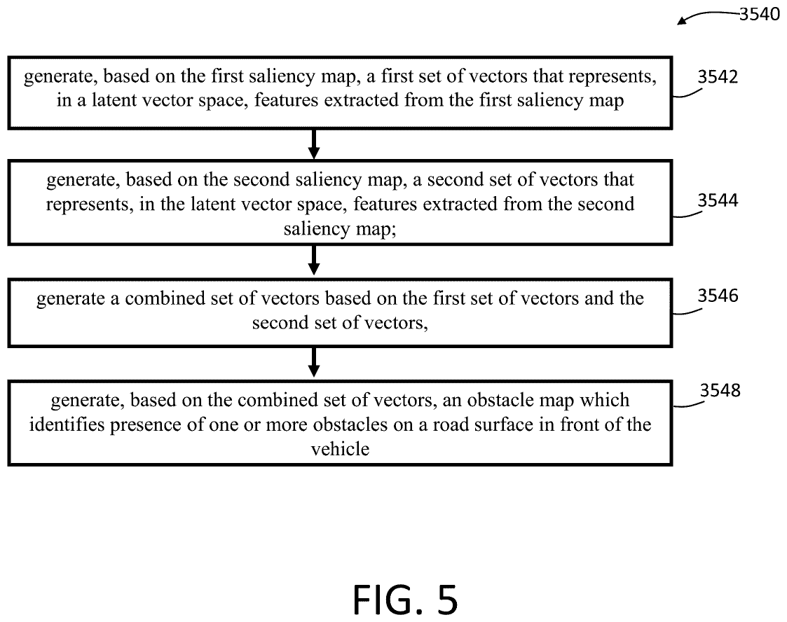

In an embodiment, the processing circuit 1130 may be programmed by one or more computer-readable or computer-executable instructions stored on the non-transitory computer-readable medium 1140. The non-transitory computer-readable medium 1140 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 1140 may form, e.g., a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 1140 may store computer-executable instructions or computer-readable instructions, such as instructions to perform the below methods described in connection with FIGS. 3 and 5.

In various embodiments, the terms “computer-readable instructions” and “computer-executable instructions” are used to describe software instructions or computer code configured to carry out various tasks and operations. In various embodiments, if the computer-readable or computer-executable instructions form modules (as illustrated in FIG. 1B), the term “module” refers broadly to a collection of software instructions or code configured to cause the processing circuit 1130 to perform one or more functional tasks. The modules and computer-readable/executable instructions may be described as performing various operations or tasks when a processing circuit 1130 or other hardware component is executing the modules or computer-readable instructions.

In some implementations, the processing circuit 1130 and/or object detection computing system 1100 may be part of, or may form, a vehicle control unit (also referred to as a vehicle controller) that is embedded or otherwise disposed in a vehicle (e.g., a Mercedes-Benz® car or van). For example, FIG. 1B illustrates a more specific example in which the system 1000 of FIG. 1A is a vehicle 1000A. In this example, the object detection computing system 1100 may be an electronic control unit (ECU) 1100A of the vehicle 1000A, and the communication interface 1120 may be a sensor interface for the ECU 1100A. In this example, stereo sensor system 1200 may include at least two cameras (e.g., camera 1220 and camera 1240) mounted inside or outside the vehicle 1000A. The ECU 1100A may be, e.g., part of an ADAS controller, head unit, a telematics control unit (TCU), a central powertrain controller (CPC), a central exterior & interior controller (CEIC), a zone controller, or any other controller (the term “or” is used herein interchangeably with “and/or”).

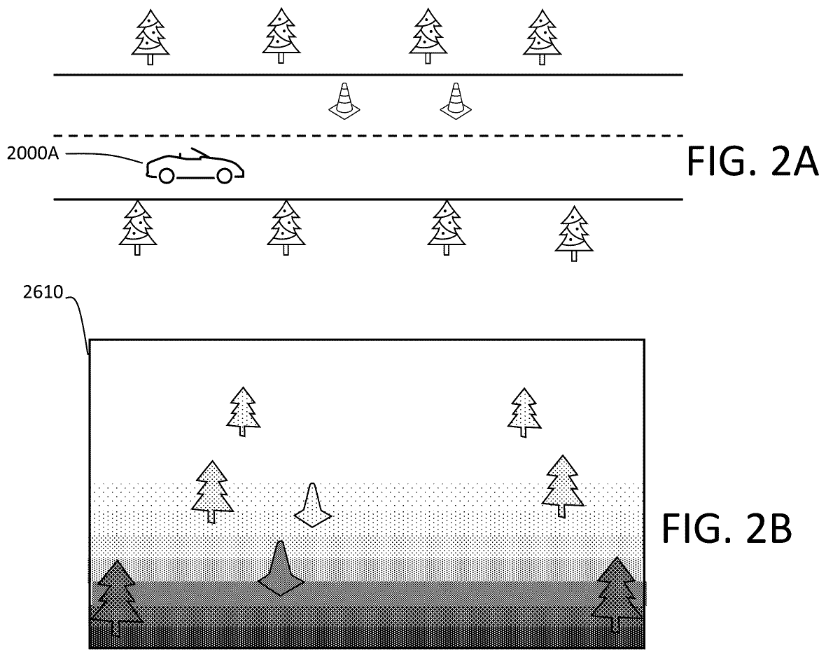

FIG. 2A illustrates an environment or space in which a vehicle 2000A may need to perform object detection. The figure depicts the vehicle 2000A (which may be an embodiment of vehicle 1000A) traveling on a road surface. In some situations, a hazard, obstacle, or other object may be present on a portion of the road surface in front of the vehicle 2000A. One aspect of the present disclosure involves detecting such objects, as discussed below in more detail. The detection may be based on disparity image information, which may be generated by the stereo sensor system 1200 of FIGS. 1A and 1B. For example, FIG. 2B depicts a disparity image 2610 which represents a space in front of the vehicle 2000A. In this example, the disparity image 2610 may be an array of pixels, wherein each pixel has a pixel value (also referred to as a disparity value or depth value) that indicates depth of a point in space represented by that pixel. For example, a higher pixel value may represent a greater depth (or, more specifically, greater distance between the vehicle 2000A and that point in space), while a lower pixel value may represent a lower depth.

FIG. 3 shows a flow chart illustrating a method 3500 of detecting objects in a space surrounding a vehicle, according to examples described herein. In the below discussion of the method of FIG. 3, reference may be made to features described with respect to FIGS. 1A, 1B, 2A, and 2B. In an embodiment, the steps described with respect to the method of FIG. 3 may be performed by the object detection computing systems 1100 (or more specifically the ECU 1100A) as shown and described with respect to FIGS. 1A and 1B. Further still, certain steps described with respect to the flow chart of FIG. 3 may be performed prior to, in conjunction with, or subsequent to any other step, and need not be performed in the respective sequences shown. Further, the method 3500 may include additional steps than those illustrated in FIG. 3, and may in some embodiments omit one or more of the steps illustrated in FIG. 3.

As discussed below in more detail, the method 3500 may generate multiple saliency maps from disparity image information, wherein the multiple saliency maps are generated using different algorithms that leverage different aspects of how obstacles or other objects may appear in a disparity image. These different aspects may highlight different ways in which the geometry of obstacles appear in the disparity image. This approach may thus fuse multiple geometric approaches operating on disparity image information to identify objects, including small, unstructured objects or obstacles on a road surface in front of a vehicle. In some implementations, the object detection technique may execute a weighted sum model on the multiple saliency maps to identify and/or classify the detected objects. In some instances, the computing system can execute a lifting function on each saliency map to generate a three-dimensional vector field, and may then combined the vector fields corresponding to each saliency map such that each pixel of the disparity image is represented by a three-dimensional vector. The computing system may then perform a coordinate transformation or clustering technique on the combined vector field to generate a two-dimensional obstacle map that identifies and/or classifies the objects (e.g., using bounding boxes).

In an embodiment, the method 3500 may include step 3510, in which an object detection computing system (e.g., 1100 of FIG. 1A or 1100A of FIG. 1B), or more specifically its processing circuit (e.g., 1130) receives disparity image information (also referred to as disparity image data) representing a space outside a vehicle (e.g., vehicle 2000 of FIG. 2A). The disparity image information may be, e.g., a disparity image (also referred to as a disparity map) which provides depth information for a scene captured by a stereo sensor system, or more specifically a stereo camera system (e.g., stereo sensor system 1200 of FIG. 1B), to convey depth of various parts of the scene relative to the stereo sensor system or relative to the vehicle. In an embodiment, the disparity image information may be a disparity image (e.g., 2610) having m rows and n columns of pixels (to form a m×n disparity image), and the columns of pixels in the disparity image may be oriented along a vertical dimension of the space outside the vehicle. The pixel values of the disparity image may also be referred to as disparity values.

In an embodiment, the disparity image may be generated based on a comparison of at least two images captured by at least two respective cameras (e.g., 1220 and 1240) or camera lenses. In one example, each pixel of the disparity image may represent a difference in position of corresponding pixels observed in the two images. For instance, the difference may reflect a comparison in a horizontal shift between matching points in the two images, which may arise due to differing viewpoints of the cameras/camera lenses that captured the two images. In this example, each pixel of the disparity image may have a magnitude which is, e.g., proportional or inversely proportional to a distance between a point in space represented by that pixel and the cameras/camera lenses of the stereo camera system. The point in space represented by that pixel of the disparity image may be, e.g., a point on a surface or object corresponding to that pixel. Additionally, the comparison or other calculation may be performed by the stereo camera system, or by the object detection computing system 1100. For instance, the stereo camera system may perform this comparison or other calculation, and generate the disparity image (e.g., 2610). In such implementations, the disparity image information received by the system 1100 is the disparity image. In some implementations, the disparity image information received by the system 1100 may be the multiple images captured by the stereo camera system (e.g., an image generated by camera 1220 and an image generated by camera 1240). In such implementations, the object detection computing system 1100 may generate the disparity image based on the multiple images. Thus, the disparity image information may be based on sensor information from a stereo camera system, or more generally stereo sensor system, of the vehicle.

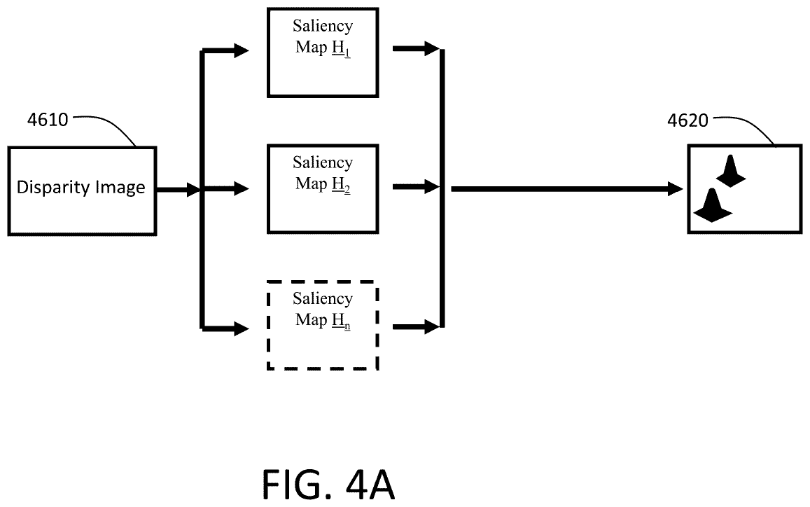

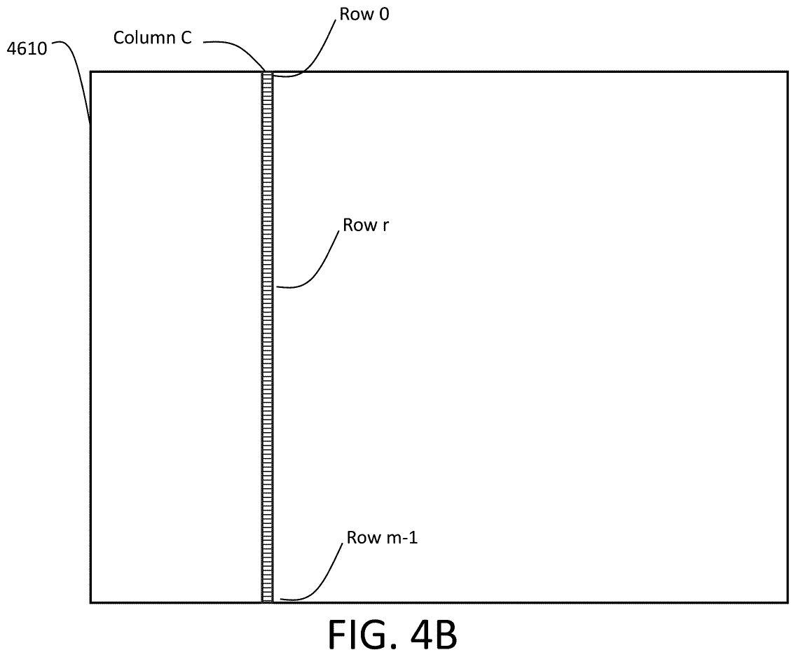

Referring back to FIG. 3, the method 3500 may, in an embodiment, include a step 3520, in which the object detection computing system (e.g., 1100) generates, based on the disparity image information, a first saliency map that indicates probability of one or more objects being present in the space outside the vehicle (e.g., a space in front of the vehicle). For instance, FIG. 4A illustrates an example in which step 3520 involves generating a saliency map H₁ based on a disparity image 4610. In an embodiment, the saliency map H₁ may include pixels that correspond to pixels of a disparity image 4610, and have pixel values (also referred to as saliency values) that identify regions of interest within the disparity image 4610. If the disparity image 4610 represents a scene in front of a vehicle (e.g., 2000A), the regions of interest in the disparity image 4610 may correspond to, e.g., portions of the scene that are likely to represent obstacles or other objects in front of the vehicle. As discussed below in more detail, the first saliency map H₁ may be used to enable efficient and accurate feature extraction to interpret a space surrounding a vehicle, and more specifically to detect objects in a space in front of the vehicle. For example, a saliency map in this disclosure may be a heat map which identifies which corresponding regions of the disparity image represent objects or features of interest, such as an obstacle in front of a vehicle. A higher pixel value in the saliency map (that is, a higher saliency value) may correspond to a higher probability that the corresponding pixel captures an obstacle or other object in the scene, while a lower pixel value in the saliency map (that is, a lower saliency value) may correspond to a lower probability that the corresponding pixel captures an obstacle or other object in the scene.

In an embodiment, step 3520 may generate the first saliency map (e.g., H₁) using a first algorithm which is based on a first image property that describes change among pixel values of the disparity image information. As discussed above, one aspect of the present disclosure involves generating at least two saliency maps using two different respective algorithms. The first algorithm may rely on the first image property to generate, as part of step 3520, the first saliency map (e.g., H₁ of FIG. 4A), while a second algorithm may rely on a second image property to generate, as part of step 3530 (discussed below in more detail), a second saliency map (e.g., H₂ of FIG. 4A). The second image property may be different than the first image property, and more specifically may focus on different geometric features of how potential obstacles or other features may appear in a scene, including obstacles on a road surface. For instance, both the first image property and the second image property may measure change among pixel values of the disparity image 4610, but may rely on different aspects of how features or regions of interest may appear in a disparity image, in order to more robustly identify such regions or features of interest (e.g., objects in front of a vehicle) and to avoid false negatives or other false detections.

In an embodiment, the first image property may be a first derivative of pixel values of a disparity image, or, more specifically, a first derivative of pixel values along one or more columns of the disparity image. For example, step 3520 may involve generating a first saliency map H₁ based on a first derivative of pixel values of the disparity image 4610 of FIG. 4A. In such an embodiment, the first saliency map H₁ may be used to identify or “separate” out salient features (e.g., a potential obstacle) in the disparity image 4610 from a general landscape (e.g., a road surface) that the potential obstacle appears against in the disparity image 4610. In this example, the disparity image 4610 may capture a general landscape (e.g., road surface) that features a steady change in distance or depth, wherein this steady change may also be referred to as a “slant” or gradient in distance or depth values, because successive portions of the general landscape may be successively farther from or closer to a point of reference (e.g., location of the stereo camera system) for the disparity image 4610.

In some implementations, the object detection computing system 1100 may generate the first saliency map H₁ in a manner in which decreases in values of the first derivative lead to increases in values of the first saliency map H₁, such that the decreases in the values of the first derivative are associated with increases in probability the disparity image 4610 capturing one or more objects being in the space outside the vehicle. Such implementations may correspond to a scenario in which an object appearing against the general landscape (e.g., an object on the road surface) may have much lower or zero change in distance or depth values. This is because, while the general landscape captured by the disparity image 4610 may feature a steady gradient in depth or distance values relative to the stereo camera system, the object which appears against this general landscape may have substantially the same distance or depth among various points on the object's surface. The saliency map H₁ may, e.g., reflect regions in the disparity image 4610 showing zero or very low change in distance or depth values, and may assign higher saliency values to those regions.

In a more specific example, step 3520 may execute a disparity slant algorithm that measures how pixel values of the disparity image 4610 change along columns of the disparity image 4610. For example, if the disparity image 4610 is a 2D array of pixels having m rows and n columns, the disparity slant algorithm may generate the first saliency map H₁ by determining a first derivative of pixel values along individual columns of the disparity image 4610. Such a determination may yield, for each column of pixels of the disparity image 4610, a corresponding column of derivative values, which may measure or represent a “slant”, or first-order rate of change, for pixel values along the column of the disparity image. In this example, the pixel values of first saliency map H₁ (also referred to as saliency values) may be formed using the column of derivative values.

In one example, the first saliency map H₁ may identify where corresponding regions of the disparity image (e.g., 4610) have a first derivative which is low or zero in value, and the method 3500 may rely on taking such regions into account when detecting where obstacles or other features of interest are located outside of a vehicle. In this example, the vehicle may be traveling or otherwise located on a road surface, and the disparity image 4610 may represent a space in front of the vehicle. If the disparity image 4610 has regions that capture the road surface, such regions of the disparity image 4610 corresponding to the road surface may have an expected derivative value, also referred to as an expected disparity slant value d_exp. That is, the columns of the disparity image 4610 in those regions may have a non-zero first derivative of d_exp, because each column of the disparity image 4610 in those regions may be describing the road surface steadily extending away from or toward the vehicle, such that the disparity image 4610 shows a steady gradient in pixel values to reflect different portions of the road surface being at different distances relative to the vehicle.

In such an example, if the disparity image has another region in which pixel values along the columns of that region have a derivative which is zero, or more generally below a defined threshold, such a region of the disparity image 4610 may have a high probability of depicting a feature different from the road surface, or more specifically an object appearing on the road surface. For instance, such a region of the disparity image 4610 may be capturing a front-side of the object facing the vehicle. That side of the object may have a generally uniform distance from the front of the vehicle. Thus, if pixel values of the disparity image 4610 represent depth or distance relative to the front of the vehicle, then if the disparity image 4610 has a region that captures an object on the road surface, the pixel values in that region may have a first derivative which is zero or near-zero along columns of that region. This is because the corresponding pixels may represent points of an object that have the same or nearly the same distance relative to the front of the vehicle. In this example, step 3520 may leverage the above geometric assumption of how objects may appear in a disparity image, in which low values of the first derivative may lead to higher saliency values for the first saliency map H₁. More specifically, lower values of the first derivative in the disparity image 4610 may lead to higher saliency values in the first saliency map H₁, while higher values of the first derivative may lead to lower saliency values in the first saliency map H₁.

In a more specific implementation, step 3520 may generate the first saliency map (e.g., H₁) by identifying regions of the disparity image (e.g., 4610) which have a first derivative that is less than an expected disparity slant value d_exp. In an embodiment, if the disparity image 4610 is generated using a stereo camera mounted in a vehicle that is on a road surface, the expected disparity slant value may refer to a value of the first derivative that is expected for pixel values of the disparity image 4610 representing the road surface, and may be calculated as:

d_exp=(camera_baseline/camera_height)

As stated above, the first derivative among pixel values of a disparity image may also be referred to as a disparity slant, and a first algorithm which determines the first derivative among the pixel values of the disparity image may also be referred to as a disparity slant algorithm. In an embodiment, if the disparity slant algorithm is performed on a m×n disparity image d (e.g., disparity image 4610 of FIGS. 4A and 4B) to determine the first derivative of pixel values of the disparity image along each of its columns, the disparity slant may be calculated multiple successive points along a column, such as column c of the disparity image 4610 of FIG. 4B. In this example, the multiple points at which the disparity slant is calculated may correspond to multiple rows, where the disparity slant for row r is determined based on the following:

disparity_slant(r,c)=(d_plus−d_minus)/(2×Δ_r)
where r refers to a particular row of the disparity image (which may also be the same row for the saliency map H₁),
where c refers to a particular column of the disparity image, and may remain constant while the disparity slant is being determined at multiple points for that particular column

where d_plus=d(r+Δ_r,c); d_minus=d(r−Δ_r,c); d=d(r,c);
Δ_r=a distance or step size between reference points by which to measure a change in pixel values between those reference points (e.g., Δ_r could be 1, or some other number); and

In one example, if d_plus−d_minus for a region of the disparity image is greater than 2×d_exp, the resulting disparity slant may be considered high, and step 3520 may cause the saliency map H₁ to indicate low saliency for that region.

As another example, if d_plus−d_minus>scale×d_exp, where scale is potentially a distance-dependent parameter or a constant (e.g., 0.2), then the disparity slant may be calculated based on the following formula:

disparity_slant=max((d_plus)/Δ_−r,(d−d_minus/Δ_r); else

disparity_slant=(d_plus−d_minus)/(2×Δ_r)

Returning to FIG. 3, method 3500 may in an embodiment include a step 3530, which may occur before, in parallel with, or after step 3520. In step 3530, the object detection computing system 1100 may generate, based on the disparity image information, a second saliency map that also indicates probability of one or more objects being present in the space outside the vehicle. FIG. 4A illustrates an example in which the object detection computing system 1100 may generate a second saliency map H₂ based on the disparity image 4610. As discussed above, the system 1100 may generate a first saliency map in step 3520 using a first algorithm, and generate the second saliency map in step 3530 using a second algorithm different than the first algorithm. For instance, the first algorithm and the second algorithm may be based on different respective image properties. In some implementations, both image properties may describe change among pixel values of the disparity image, but are still different image properties. The first image property (e.g., first derivative among pixel values) used by the first algorithm may detect features/objects of interest from the disparity image based on one geometric aspect of how such features/objects of interest will appear in a disparity image (e.g., a low value in the first derivative may correspond to high saliency, and vice versa), while the second image property used by the second algorithm may detect features of interest from the disparity image based on another geometric aspect of how such features/objects of interest will appear in the disparity image.

In an embodiment, step 3530 may generate the second saliency map using an algorithm based on a second derivative of the pixel values of the disparity image (e.g., second derivative of pixel values along one or more columns of the disparity image). Thus, step 3520 may generate a first saliency map based on a first derivative among pixel values of the disparity image, while step 3530 may generate the second saliency map based on the second derivative of the pixel values of the disparity image. The first derivative may detect or measure a “slant” in pixel values along, e.g., a column of pixels in the disparity image, while the second derivative may detect or measure a “curvature” in pixel values along, e.g., the column of pixels in the disparity image. Thus, an algorithm which measures a second derivative among pixel values of the disparity image may be referred to as a disparity-based local curvature algorithm.

In an embodiment, the object detection computing system 1100 may perform step 3530 in a context in which the disparity image represents a road surface in front of a vehicle. In such an embodiment, the system 1100 may generate the second saliency map in a manner in which increases in values of the second derivative leads to increases in values of the second saliency map, such that the increases in the values of the second derivative are associated with increases in probability of the disparity image capturing a transition between the road surface and one or more objects in front of the vehicle

More specifically, the second saliency map may identify regions in a disparity image which represent a transition between an object (e.g., obstacle in front of a vehicle) and a general landscape against which the object appears (e.g., road surface). For instance, if the disparity image captures a road surface or other landscape, regions in the disparity image corresponding to the road surface may indicate distance or depth values that change steadily, because successive portions of the road surface are successively farther from or closer to a stereo camera which generated the disparity image. The steady rate of change in the depth or distance values may be reflected by a non-zero first derivative among the depth or distance values, but may have a zero second derivative. In other words, for regions of a disparity image which capture only a road surface or other landscape, the distance or depth values for those regions in the disparity image may show a “slant” in distance or depth values, but no “curvature” in the distance or depth values. However, if the disparity image has a region which shows a transition between an object and the road surface (or other landscape), the transition may be associated with an abrupt change in a gradient among the distance or depth values, because the road surface may be associated with one gradient among the distance or depth values, while the object may be associated with a different gradient (e.g., zero gradient) among the distance or depth values. Thus, a region in the disparity image that represents a transition between the object and the road surface may feature a non-zero second derivative among its distance or depth values. In other words, such a region may show a local “curvature” among distance or depth values of the disparity image. Thus, if step 3530 uses a second algorithm which is based on a second derivative of pixel values of a disparity image, such an algorithm may be referred to as a disparity-based local curvature algorithm, which may detect a transition between, e.g., a road surface and a lower portion (e.g., foot) of a potential object on the road surface.

In an embodiment, the disparity-based local curvature algorithm may be applied to the m×n disparity image d to determine the second derivative of pixel values along each of its columns, based on the following:

Curvature C=(d_plus−2×d_minus)/Δ_r
where, as discussed above, d_plus=d(r+Δ_r,c,); d_minus=d(r−Δ_r,c); d=d(r,c); and
Δ_r=a distance or step size between reference points by which to measure a change in pixel values between those reference points
(r=the row of the disparity image, and c refers to a particular column of a disparity image, and may be constant for that particular column)

In certain examples, Δ_r may be set to a value where noise is sufficiently low (e.g., too low a value for Δ_r will result in high noise). For a disparity image that records or captures a road surface, curvature C for a given pixel or sequence of pixels would be zero unless those sequence of pixels capture a transition between the road surface and a potential object on the road. Thus, a non-zero value for C may result when a transition is detected between the road surface and a potential object. Accordingly, the disparity-based local curvature algorithm may detect the foot points (or more generally a lower portion) of potential objects on the road surface, and a greater value of C may correspond to a greater saliency in the saliency map H₂, or more specifically a greater probability that the non-zero second derivative corresponds to an object or hazard on the road surface.

Thus, referring to FIG. 4A, some implementations of the present disclosure may apply a disparity-based slant algorithm to generate a first saliency map H₁ based on a disparity image 4610, and apply a disparity-based curvature algorithm to generate a second saliency map H₂ based on the disparity image 4610. In these implementations, the first saliency map H₁ may be used to detect an object appearing against a landscape (e.g., road surface) in the disparity image, wherein regions of the disparity image with zero or very low “slant” among pixel values (or more generally first derivative among pixel values) may indicate uniform or very low variation in depth or distance, and may be associated with higher saliency in the first saliency map H₁. In such implementations, the second saliency map H₂ may be used to detect a transition between an object and its landscape, wherein a region of the disparity image having a higher “curvature” among pixel values (or more generally second derivative among pixel values) may be associated with a higher saliency in the second saliency map H₂.

Thus, method 3500 relies on using at least a first saliency map and a second saliency map to identify features or objects of interest in a space around a vehicle, where the two saliency maps may be based on different respective image properties, such as disparity slant and disparity curvature, so as to focus on different aspects or assumptions regarding a geometry of an object or feature of interest may appear in a disparity image. By using at least both of these saliency maps, the method 3500 may enhance its ability to detect objects of interest in various situations, such as detecting small objects (e.g., hazards) on a road surface at relatively large distances. Thus, the object detection computing system 1100 can generate multiple saliency maps as heat maps (e.g., in real time) based on the disparity information of each disparity image, in which high saliency in the saliency maps corresponds to a high probability of, e.g., an object or hazard, and low saliency corresponds to, e.g., a low probability of an object or hazard.

In an embodiment, method 3500 may generate the first saliency map (e.g., H₁) and the second saliency map (e.g., H₂) simultaneously. In other embodiments, the first saliency map and the second saliency map may be generated in a sequential manner. In an embodiment, method 3500 may generate one or more additional heat maps (e.g., H₃) beyond the first saliency map and the second saliency map, using an algorithm different from the first algorithm of step 3520 and the second algorithm of step 3530. In some implementations, the only saliency map used in method 3500 may be the first saliency map and the second saliency map. In certain implementations, the object detection computing system may generate the saliency maps by executing the above algorithms in real time as pipelines in an on-board computing system of an autonomous vehicle.

In an embodiment, each of the disparity-based local curvature algorithm and the disparity slant algorithm may average multiple disparities (e.g., in small windows), which can involve repeating the same operation for neighboring pixels, such as the pixels on either side and the pixel above the computed pixel. The resultant curvatures and disparity_slants may then be summed and/or averaged to provide a more reliable estimate (e.g., with less noise).

In various implementations, the curvature (C) resulting from the disparity-based local curvature algorithm and the disparity_slant resulting from the disparity slant algorithm can be mapped to saliency. For example, the saliency can comprise the absolute floating value (fabs) multiplied by a scale factor, where the scale factor comprises a particular parameter. For example, the saliency may be determined (e.g., in real-time) based on the following:

curvature saliency for first saliency map=fabs(curvature)×scale factor; and

displarity_slant saliency for second saliency map=fabs(disparity_slant)×scale factor

As stated above, the method 3500 illustrated in FIG. 3 may include more steps than that shown in the figure, or may omit one or more steps. In some instances, two or more steps (e.g., 3520 and 3530) may occur in parallel. In some instances, one or more steps (e.g., 3520 and 3530) may occur after a previous step (e.g., 3510). In some instances, the method 3500 may involve generating one or more additional saliency maps based on the disparity image information, such as a third saliency map. In such instances, the one or more additional saliency maps may be generated based one respective one or more algorithms (e.g., v-disparity and/or fast planar hypothesis) that differ from the algorithms of steps 3520 and 3530.

Returning to FIG. 3, the method 3500 may in an embodiment include a step 3540, in which the object detection computing system 1100 identifies, based on at least both the first saliency map and the second saliency map, presence of one or more objects being present in the space outside a vehicle (e.g., 2000). For example, as illustrated in FIG. 4A, the system 1100 may generate an obstacle map 4620 based on the first saliency map H₁ and the second saliency map H₂, wherein the obstacle map 4620 identifies presence of one or more obstacles or other objects in front of the vehicle. If the system generates one or more additional saliency maps (e.g., Hₙ), then the obstacle map 4620 may be generated based on the one or more additional saliency maps.

In some implementations, step 3540 may involve projecting each of the saliency maps into a latent vector space, and extracting objects or features of interest by combining features in the latent vector space. For instance, FIG. 5 illustrates example operations or sub-steps which could be performed as part of step 3540.

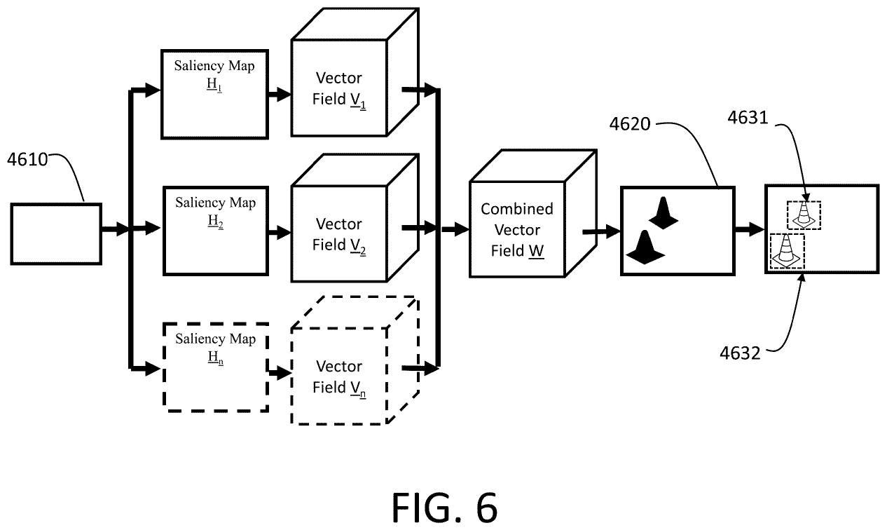

In this example, step 3540 could involve an operation 3542, in which the object detection computing system 1100 generates, based on the first saliency map, a first set of vectors that represents, in a latent vector space, features extracted from the first saliency map. For instance, FIG. 6 illustrates an example in which, like the embodiment illustrated in FIG. 4A, the system 1100 generates the first saliency map H₁ and the second saliency map H₂ (also discussed with respect to FIG. 4A). In this example, the system 1100 generates a first set of vectors V₁ based on the first saliency map H₁. In an embodiment, the object detection computing system 1100 in step 3542 may generate first set of vectors (e.g., V₁) using a lifting function which converts the first saliency map (e.g., H₁) into a higher-dimensional latent vector space. As an example of a lifting function, the system 1100 may multiply each pixel value of the first saliency map (that is, multiple each saliency value of the first saliency map), with a respective weight, wherein the respective weight may be used as a magnitude for a respective vector of the latent vector space.

Returning to FIG. 5, step 3540 may in an embodiment further include a step 3544, in which the object detection computing system 1100 generates, based on the second saliency map, a second set of vectors that represents, in the latent vector space, features extracted from the second saliency map. For instance, FIG. 6 illustrates a vector field V₂ being generated based on the second saliency map H₂. In some implementations, the system 1100 may generate the vector field V₂ using a lifting function, such as the lifting function discussed above with respect to step 3542. In an embodiment, the system 1100 in step 3540 may generate a respective set of vectors (e.g., Vₙ) for each saliency map (e.g., H₁−Hₙ) involved in the step.

In an embodiment, step 3540 may include a step 3546, in which the object detection computing system 1100 generates a combined set of vectors based on at least the first set of vectors and the second set of vectors. For example, as illustrated in FIG. 6, step 3546 may involve generating a combined vector field W based on at least the vector field V₁ and the vector field V₂. If the step involves more vector fields (e.g., Vₙ), the combined vector field W may be based on those additional vector fields as well.

In some implementations, step 3546 may involve adding the vector fields, or projected components of the vector fields. For example, the object detection computing system 1100 may generate the combined vector field W by projecting the first vector field V₁ and the second vector field V₂ into a two-dimensional space, such as a space defined by a x-axis and γ-axis. In some cases, the system 1100 may generate weighted sums of the projection of the first vector field V₁ along one axis (e.g., x-axis) and the projections of the second vector field V₂ along the same axis (e.g., x-axis), and use the weighted sums to generate the combined vector field W. In some other cases, the system 1100 may determine a projection of the first vector field V₁ along one axis (e.g., x-axis) and a projection of the second vector field V₂ along an orthogonal axis (e.g., y-axis), and generate the combined vector field W based on a quadratic mean of the two projections.

Returning to FIG. 5, the step 3540 may in an embodiment include a step 3548, in which the object detection computing system 1100 generates, based on the combined set of vectors, an obstacle map which identifies presence of one or more obstacles, such as obstacles on a road surface in front of the vehicle. For instance, the object detection computing system 1100 may project the combined vector field W into a two-dimensional space, so as to generate a map, and may identify regions of the map which have values above a defined threshold as being an obstacle. As an example, FIG. 6 illustrates an obstacle map 4620 that identifies multiple obstacles on a road surface in front of the vehicle. In an embodiment, steps 3542 through 3546 may combine all saliency maps (or obstacle cues) in a latent vector space, while step 3548 may generate a two-dimensional obstacle map based on the combined saliency map signals. As an example, the system 1100 may execute a coordinate transformation or perform a clustering technique on the combined vector field W to generate the two-dimensional obstacle map. In an embodiment, the system 1100 may perform an optimized affine transformation determined by parameter optimization (e.g. evolutionary algorithms, gradient decent, grid search) to generate the obstacle map from the combined vector field.

In some implementations, the system 1100 may use the obstacle map to identify semantic content or perform segmentation for on an image (e.g., disparity image) being captured by a vehicle. For example, as illustrated in FIG. 6, the system 1100 may perform an image segmentation operation that generate one or more bounding boxes 4631 and 4632 around parts of an image, wherein the parts having the bounding boxes 4630 correspond to where obstacles are identified in the obstacle map 4620. In some instances, the system 1100 may generate a 3D obstacle list based on the obstacle map. Furthermore, once the system 1100 has generated one or more bounding boxes 4631 and 4632 corresponding to one or more obstacles, the system 1100 may determine and perform a motion planning operation based on the obstacle map 4620 to transmit a signal to a vehicle to perform operations such that the vehicle avoids collision with the one or more obstacles.

It is further contemplated that the combination of saliency maps, or stacked saliency map, can be generated using an optimized affine transformation determined by parameter optimization (e.g. evolutionary algorithms, gradient decent, grid search, etc.), where the output image is represented, for example, by the magnitude of the saliency vector field, which can represent an obstacle map. In variations, the stacked saliency map can be generated via a learning-based approach (e.g., an arbitrary mapping to an output image). In contrast to learning based on color data from scratch, several geometric cues may be integrated in the saliency maps before implementing machine learning (e.g., requiring less training data). It is also contemplated that a direct prediction of two-dimensional bounding boxes identifying objects may be performed using the stacked saliency map.

### ADDITIONAL DISCUSSION OF VARIOUS EMBODIMENTS

Embodiment 1 relates to an object detection computing system. The object detection system may include a communication interface configured to access or receive disparity image information based on sensor information from a stereo sensor system of a vehicle, wherein the disparity image information represents a space outside the vehicle. The object detection system may also include a processing circuit and a non-transitory computer-readable medium. The non-transitory computer-readable medium stores instructions that, when executed by the processing circuit, cause the processing circuit to receive, via the communication interface, the disparity image information representing the space outside the vehicle. The processing circuit generates, based on the disparity image information, a first saliency map that indicates probability of one or more objects being present in the space outside the vehicle, wherein the first saliency map is generated using a first algorithm which is based on a first image property that describes change among pixel values of the disparity image information. The processing circuit also generates, based on the disparity image information, a second saliency map that also indicates probability of one or more objects being present in the space outside the vehicle, wherein the second saliency map is generated using a second algorithm which is based on a second image property different than the first image property, wherein the second image property also describes change among pixel values of the disparity image information. Additionally, the processing circuit identifies, based on both the first saliency map and the second saliency map, presence of one or more objects being present in the space outside the vehicle.

Embodiment 2 includes the object detection computing system of Embodiment 1. In this embodiment the disparity image information is a disparity image having rows and columns of pixels. The columns of pixels are oriented along a vertical dimension of the space outside the vehicle. The first image property is a first derivative of pixel values along one or more of the columns of the disparity image, such that the one or more processors are configured to generate the first saliency map based on the first derivative of the pixel values along one or more of the columns of the disparity image.

Embodiment 3 includes the computing system of Embodiment 1 or Embodiment 2. In this embodiment the second image property is a second derivative of pixel values along one or more of the columns of the disparity image, such that the one or more processors are configured to generate the second saliency map based on the second derivative of the pixel values along one or more of the columns of the disparity image.

Embodiment 4 includes the computing system of any of Embodiments 1 to 3. In this embodiment the one or more processors are configured to generate the first saliency map in a manner in which decreases in values of the first derivative leads to increases in values of the first saliency map, such that the decreases in the values of the first derivative are associated with increases in probability the disparity image capturing one or more objects being in the space outside the vehicle.

Embodiment 5 includes the computing system of any of Embodiments 1 to 4. In this embodiment the one or more processors are configured, when the disparity image represents a road surface in front of the vehicle, to generate the second saliency map in a manner in which increases in values of the second derivative leads to increases in values of the second saliency map, such that the increases in the values of the second derivative are associated with increases in probability of the disparity image capturing a transition between the road surface and one or more objects in front of the vehicle.

Embodiment 6 includes the computing system of any of Embodiments 1 to 5. In this embodiment the memory stores instructions that, when executed by the one or more processors, cause the one or more processors to generate, based on the disparity image information, one or more additional saliency maps based on respective one more algorithms that differ from the first algorithm and differ from the second algorithm. The one or more processors are configured to determine the presence of one or more objects based on the first saliency map, the second saliency map, and the one or more additional saliency maps.

Embodiment 7 includes the computing system of any of Embodiments 1 to 6. In this embodiment the memory stores instructions that are executed by the one or more processors. The one or more processors generate, based on the first saliency map, a first set of vectors that represents, in a latent vector space, features extracted from the first saliency map. The one or more processors also generate, based on the second saliency map, a second set of vectors that represents, in the latent vector space, features extracted from the second saliency map. Additionally, the one or more processors generate a combined set of vectors based on the first set of vectors and the second set of vectors and the one or more processors are configured to identify the presence of one or more objects outside the vehicle based on the combined set of vectors.

Embodiment 8 includes the computing system of any of Embodiments 1 to 7. In this embodiment the first set of vectors and the second set of vectors are, respectively, a first vector field and a second vector field. The combined set of vectors is a combined vector field that combines the first vector field and the second vector field. Additionally, the one or more processors are configured to generate the first vector field and the second vector field by applying a lifting function to, respectively, the first saliency map and the second saliency map.

Embodiment 9 includes the computing system of any of Embodiments 1 to 8. In this embodiment the memory includes instructions which cause the one or more processors to generate, based on the combined set of vectors, an obstacle map which identifies the presence of one or more obstacles on a road surface in front of the vehicle.

Embodiment 10 includes the computing system of any of Embodiments 1 to 9. In this embodiment the memory includes instructions which cause the one or more processors to perform an image segmentation operation that generates respective one or more bounding boxes for identifying the one or more obstacles.

Embodiment 11 includes the computing system of any of Embodiments 1 to 10. In this embodiment the memory includes instructions for causing the one or more processors to perform, based on the obstacle map, a motion planning operation for planning motion of the vehicle in a manner that avoids collision with the one or more obstacles.

### ADDITIONAL DISCLOSURE

The above embodiments may support robust obstacle detection, such as for an automated driving system or driving assistance system. For instance, by using different algorithms that focus on different geometric cues to generate various saliency maps, an automated driving system discussed herein may boost object detection performance while reducing the overall uncertainty. This allows the automated driving system or driving assistance system to perform motion planning and/or vehicle control based on road hazards or other obstacles in front of a vehicle, in a manner which avoids collision with the obstacles.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude claiming rights to such combinations.

What is claimed is:

1. An object detection computing system comprising:
a communication interface configured to access or receive disparity image information based on sensor information from a stereo sensor system of a vehicle, wherein the disparity image information represents a space outside the vehicle;
a processing circuit; and
non-transitory computer-readable medium storing instructions that, when executed by the processing circuit, cause the processing circuit to:
receive, via the communication interface, the disparity image information representing the space outside the vehicle;
generate, based on the disparity image information, a first saliency map that indicates probability of one or more objects being present in the space outside the vehicle, wherein the first saliency map is generated using a first algorithm which is based on a first image property that describes change among pixel values of the disparity image information;
generate, based on the disparity image information, a second saliency map that also indicates probability of one or more objects being present in the space outside the vehicle, wherein the second saliency map is generated using a second algorithm which is based on a second image property different than the first image property, wherein the second image property also describes change among pixel values of the disparity image information;
identify, based on both the first saliency map and the second saliency map, presence of one or more objects being present in the space outside the vehicle.

2. The object detection computing system of claim 1, wherein the disparity image information is a disparity image having rows and columns of pixels, wherein the columns of pixels are oriented along a vertical dimension of the space outside the vehicle,
wherein the first image property is a first derivative of pixel values along one or more of the columns of the disparity image, such that the one or more processors are configured to generate the first saliency map based on the first derivative of the pixel values along one or more of the columns of the disparity image.

3. The object detection computing system of claim 2, wherein the second image property is a second derivative of pixel values along one or more of the columns of the disparity image, such that the one or more processors are configured to generate the second saliency map based on the second derivative of the pixel values along one or more of the columns of the disparity image.

4. The object detection computing system of claim 3, wherein the one or more processors are configured to generate the first saliency map in a manner in which decreases in values of the first derivative leads to increases in values of the first saliency map, such that the decreases in the values of the first derivative are associated with increases in probability the disparity image capturing one or more objects being in the space outside the vehicle.

5. The object detection computing system of claim 4, wherein the one or more processors are configured, when the disparity image represents a road surface in front of the vehicle, to generate the second saliency map in a manner in which increases in values of the second derivative leads to increases in values of the second saliency map, such that the increases in the values of the second derivative are associated with increases in probability of the disparity image capturing a transition between the road surface and one or more objects in front of the vehicle.

6. The object detection computing system of claim 1, wherein the memory stores instructions that, when executed by the one or more processors, cause the one or more processors to generate, based on the disparity image information, one or more additional saliency maps based on respective one more algorithms that differ from the first algorithm and differ from the second algorithm,
wherein the one or more processors are configured to determine the presence of one or more objects based on the first saliency map, the second saliency map, and the one or more additional saliency maps.

7. The object detection computing system of claim 1, wherein the memory stores instructions that, when executed by the one or more processors, cause the one or more processors to:
generate, based on the first saliency map, a first set of vectors that represents, in a latent vector space, features extracted from the first saliency map;
generate, based on the second saliency map, a second set of vectors that represents, in the latent vector space, features extracted from the second saliency map;
generate a combined set of vectors based on the first set of vectors and the second set of vectors,
wherein the one or more processors are configured to identify the presence of one or more objects outside the vehicle based on the combined set of vectors.

8. The object detection computing system of claim 7, wherein the first set of vectors and the second set of vectors are, respectively, a first vector field and a second vector field,
wherein the combined set of vectors is a combined vector field that combines the first vector field and the second vector field, and
wherein the one or more processors are configured to generate the first vector field and the second vector field by applying a lifting function to, respectively, the first saliency map and the second saliency map.

9. The object detection computing system of claim 7, wherein the memory includes instructions which cause the one or more processors to generate, based on the combined set of vectors, an obstacle map which identifies presence of one or more obstacles on a road surface in front of the vehicle.

10. The object detection computing system of claim 9, wherein the memory includes instructions which cause the one or more processors to perform an image segmentation operation that generates respective one or more bounding boxes for identifying the one or more obstacles.

11. The object detection computing system of claim 9, wherein the memory includes instructions for causing the one or more processors to perform, based on the obstacle map, a motion planning operation for planning motion of the vehicle in a manner that avoids collision with the one or more obstacles.

12. A computer-implemented method for object detection comprising:
executing a memory storing instruction by one or more processors, causing the one or more processors to receive, via a communication interface, disparity image information representing a space outside the vehicle;
generating, based on the disparity image information, a first saliency map that indicates probability of one or more objects being present in the space outside the vehicle, wherein the first saliency map is generated using a first algorithm which is based on a first image property that describes change among pixel values of the disparity image information;
generating, based on the disparity image information, a second saliency map that also indicates probability of one or more objects being present in the space outside the vehicle, wherein the second saliency map is generated using a second algorithm which is based on a second image property different than the first image property, wherein the second image property also describes change among pixel values of the disparity image information;
identifying, based on both the first saliency map and the second saliency map, presence of one or more objects being present in the space outside the vehicle.

13. The object detection computer-implemented method of claim 12, wherein the disparity image information includes a disparity image having rows and columns of pixels, wherein the columns of pixels are oriented along a vertical dimension of the space outside the vehicle;
wherein the first image property is a first derivative of pixel values along one or more of the columns of the disparity image, such that the one or more processors are configured to generate the first saliency map based on the first derivative of the pixel values along one or more of the columns of the disparity image;
wherein the second image property is a second derivative of pixel values along one or more of the columns of the disparity image, such that the one or more processors are configured to generate the second saliency map based on the second derivative of the pixel values along one or more of the columns of the disparity image.

14. The object detection computer-implemented method of claim 12, further comprising generating, via the processors, the first saliency map in a manner in which decreases in values of the first derivative leads to increases in values of the first saliency map, such that the decreases in the values of the first derivative are associated with increases in probability the disparity image capturing one or more objects being in the space outside the vehicle.

15. The object detection computer-implemented method of claim 12, further comprising generating, via the processors, the second saliency map in a manner in which increases in values of the second derivative leads to increases in values of the second saliency map, such that the increases in the values of the second derivative are associated with increases in probability of the disparity image capturing a transition between the road surface and one or more objects in front of the vehicle, when the disparity image represents a road surface in front of the vehicle.

16. The object detection computer-implemented method of claim 12, further comprising:
executing by the one or more processors, the memory storing instructions, causing the one or more processors to generate, based on the disparity image information, one or more additional saliency maps based on respective one more algorithms that differ from the first algorithm and differ from the second algorithm;
determining, via the processors, the presence of one or more objects based on the first saliency map, the second saliency map, and the one or more additional saliency maps.

17. The object detection computer-implemented method of claim 12, further comprising:
executing by the one or more processors, the memory storing instructions, causing the one or more processors to generate, based on the first saliency map, a first set of vectors that represents, in a latent vector space, features extracted from the first saliency map;
generating, based on the second saliency map, a second set of vectors that represents, in the latent vector space, features extracted from the second saliency map;
generating a combined set of vectors based on the first set of vectors and the second set of vectors; and
identifying, via the one or more processors, the presence of one or more objects outside the vehicle based on the combined set of vectors.

18. The object detection computer-implemented method of claim 17, wherein the first set of vectors and the second set of vectors are, respectively, a first vector field and a second vector field,
wherein the combined set of vectors is a combined vector field that combines the first vector field and the second vector field, and
wherein the one or more processors generate the first vector field and the second vector field by applying a lifting function to, respectively, the first saliency map and the second saliency map and wherein the memory includes instructions which cause the one or more processors to generate, based on the combined set of vectors, an obstacle map which identifies presence of one or more obstacles on a road surface in front of the vehicle.

19. The object detection computer-implemented method of claim 18, wherein the memory instructions further comprise instructions which cause the one or more processors to generate, based on the combined set of vectors, an obstacle map which identifies presence of one or more obstacles on a road surface in front of the vehicle;
perform an image segmentation operation that generates respective one or more bounding boxes for identifying the one or more obstacles;
perform, based on the obstacle map, a motion planning operation for planning motion of the vehicle in a manner that avoids collision with the one or more obstacles.

20. One or more non-transitory computer-readable media that store instructions that are executable by a control circuit to:
receive, via the communication interface, the disparity image information representing the space outside the vehicle;
generate, based on the disparity image information, a first saliency map that indicates probability of one or more objects being present in the space outside the vehicle, wherein the first saliency map is generated using a first algorithm which is based on a first image property that describes change among pixel values of the disparity image information;
generate, based on the disparity image information, a second saliency map that also indicates probability of one or more objects being present in the space outside the vehicle, wherein the second saliency map is generated using a second algorithm which is based on a second image property different than the first image property, wherein the second image property also describes change among pixel values of the disparity image information;
identify, based on both the first saliency map and the second saliency map, presence of one or more objects being present in the space outside the vehicle.
